(19) United States
(12) Patent Application Publication
(10) Pub. No.: US 2010/0310364 A1
(43) Pub. Date: Dec. 9, 2010

(54) Turbine housing and method for producing a turbine housing

(76) Inventors: Siegfried Botsch, Grafenau (DE); Christian Elsner, Fellbach (DE); Gernot Hertweck, Fellbach (DE); Markus Müller, Waiblingen (DE); Simon Raithel, Stuttgart (DE); Martin Schlegl, Rudersberg (DE); Johannes Seuffert, Ostfildern (DE)

Correspondence Address: KLAUS J. BACH, 4407 TWIN OAKS DRIVE, MURRYSVILLE, PA, 15668, US

(21) Appl. No.: 12/806,443

(22) Filed: Aug. 12, 2010

Related U.S. Application Data
(63) Continuation-in-part of application No. PCT/EP2009/000866, filed on Feb. 7, 2009.

(30) Foreign Application Priority Data
Feb. 13, 2008 (DE) 10 2008 008 856.0

(51) Int. Cl. F04D 29/44; B23P 15/04

(52) U.S. Cl. 415/212.1; 29/889.2

(57) ABSTRACT

In a turbine housing, for an exhaust gas turbocharger of an internal combustion engine with an exhaust gas guide section which has at least one spiral channel that can be coupled to an exhaust path of an exhaust tract and a reception chamber for accommodating a turbine wheel arranged downstream of the at least one spiral channel, at least one first and one second partial housing are provided, which include complementary wall regions of the at least one spiral channel and which are joined so as to form the at least one spiral channel. Also, an exhaust gas turbocharger with such a turbine housing is provided and a method for producing such a turbine housing.

This is a Continuation-In-Part application of pending international patent application PCT/EP2008/000866 filed Feb. 7, 2009 and claims the priority of German patent application 10 2008 008 856.0 filed Feb. 13, 2008.

### BACKGROUND OF THE INVENTION

The invention relates to a turbine housing for an exhaust gas turbocharger of an internal combustion engine. The invention further relates to an exhaust gas turbocharger having a turbine housing and to a method for producing a turbine housing.

Turbine housings for fluid flow machines, in particular for exhaust gas turbochargers of internal combustion engines are known from the state of the art and comprise an exhaust gas guide region, which has at least one spiral channel that can be coupled with an exhaust gas path of an exhaust tract and a reception chamber arranged downstream of the spiral channel. The reception chamber accommodates a turbine wheel, which is driven by the exhaust gas conducted through the exhaust gas guide region. The known turbine housings are thereby usually produced by casting methods, sand casting methods being used in particular.

It is disadvantageous with the known turbine housings that the geometries and tolerances of the exhaust gas guide region that can be manufactured in connection with the usual casting methods and in particular the flow properties of the spiral channel cannot be improved further due to production-technical and economical reasons or cannot be adapted optimally to different requirement profiles.

It is thus the object of the present invention to provide a turbine housing of the above-mentioned type, which has an increased design freedom and which provides for an improved adaptability to different requirement profiles.

### SUMMARY OF THE INVENTION

In a turbine housing, for an exhaust gas turbocharger of an internal combustion engine with an exhaust gas guide section which has at least one spiral channel that can be coupled to an exhaust path of an exhaust tract and a reception chamber for accommodating a turbine wheel arranged downstream of the at least one spiral channel, at least one first and one second partial housing are provided, which include complementary wall regions of the at least one spiral channel and which are joined so as to form the at least one spiral channel. Also, an exhaust gas turbocharger with such a turbine housing is provided and a method for producing such a turbine housing.

The first and the second housing parts can be formed in a simple and cost-efficient manner with a high constructive design freedom. The invention additionally makes it possible to process the two partial housings in a mechanical precise manner with smallest tolerances in all relevant regions prior to being joined. A finishing treatment of otherwise inaccessible component parts can hereby also be performed in an exact manner. The spiral channel can thereby especially be adapted to the respective requirement profile in an optimum manner, whereby corresponding improvements of the thermodynamic degree of efficiency of a flow machine provided with the turbine housing are also achieved. In contrast to the state of the art, it is further possible to form spiral channels, which have regions shaped as nozzles with minimum widths and optimum shaping, as respective cast-technical restrictions and the like do not have to be considered. The surface quality can further be improved for example in wall regions where high, possibly trans-sonic flow speeds occur during the operation of the turbine housing. Wall friction losses can hereby be reduced considerably and the operational efficiency can be increased correspondingly.

In an advantageous arrangement of the invention it is provided that the first and the second partial housing comprise stops corresponding with each other, by means of which the partial housings are positioned to each other. This eases the custom-fit maintenance of manufacturing tolerances which are particularly small, whereby the required exhaust gas tightness of the exhaust gas guide region can be ensured in a particularly simple manner.

Further advantages result in that the first and/or the second partial housing consists of a material with a high thermal load capacity, in particular a ferritic material, preferably a cast iron alloyed with silicon and/or molybdenum. As turbine housings are subjected to frequent temperature changes during operation, there is a danger of thermal fatigue. The durability and reliability of the turbine housing can be ensured in a reliable manner by a material with a high thermal load capacity. Ferritic materials and preferably cast iron have hereby the advantage of low heat tensions and a corresponding high resistance to temperature change. The alloying of silicon is connected with an advantageous increase of the tensile strength, the yield stress and the hardness. In contrast, molybdenum increases the heat resistance and the creep rigidity of the cast iron in an advantageous manner.

In a further advantageous arrangement of the invention, the first and/or the second partial housing has a recess for receiving particles, dirt or similar. Mechanical disturbances in the connection region between the two partial housings are hereby prevented in a reliable manner.

In a further advantageous arrangement of the invention it is provided that the first and/or the second partial housing comprises are preferably annular circumferential groove in the connection region, in which an additional material is arranged at least in sections, by means of which a material-fit connection of the two partial housings is made. A mechanically particular stable, custom-fit and operation-safe connection of the two partial housings is hereby facilitated. The groove can for example be formed in an elongate manner along the connection region of the partial housings, whereby a correspondingly high contact surface is given. By means of the material-fit connection between the two partial housings, the required exhaust gas tightness of the spiral channel can additionally be ensured in a particularly simple manner.

In a further advantageous embodiment of the invention it is provided that the first and/or the second partial housing comprises a projecting and preferably annular circumferential surface region, at which is arranged an additional material at least in sections, by means of which a material-fit connection of the two partial housings is made. This provides an alternative or additional possibility to connect the two partial housings in a simple and operation-safe manner. By means of the projecting surface area forming a ledge, a fast and simple positioning of the further additional material can be carried out. Additionally, a possible welding is facilitated due to the exposed positioning of the additional material.

It has thereby been shown to be advantageous in a further embodiment that the additional material consists of the same material as the first and/or the second partial housing. In this manner, undesired tension conditions during the operation of the turbine housing are prevented in a reliable manner. The first and the second partial housing are thereby preferably manufactured of the same material.

In a further advantageous embodiment of the invention it is provided that at least the additional material and/or the further additional material has a suitable nickel mass content. The welding properties of the additional material and possibly of the partial housings can be improved in this manner

Further advantages result in that the first and/or the second partial housing comprises at least one further spiral channel that can be coupled to a further exhaust path. The turbine housing can hereby also be coupled to exhaust tracts having several paths, whereby an additional increased adaptability to different requirement profiles is given.

It has been shown to be advantageous in a further arrangement that the spiral channel and the further spiral channel are formed in a symmetrical and/or asymmetrical manner. The turbine housing according to the invention can hereby be adapted to different requirement profiles in a particularly flexible manner.

In a further aspect, the invention relates to an exhaust gas turbocharger for an internal combustion engine with a turbine housing according to one of the previous embodiments. The exhaust gas turbocharger can be operated with a plurality of internal combustion engines in this manner due to the increased constructive degree of design freedom and the improved adaptability of the turbine housing to different requirement profiles with an improved degree of efficiency.

The exhaust gas turbocharger can for example be coupled to Otto and also to Diesel engines. The exhaust gas turbocharger can also be used for internal combustion engines with exhaust tracts having several paths and/or exhaust gas after treatment or exhaust gas recirculation system, wherein corresponding emission-relevant optimizations and fuel savings can be achieved due to the improved adaptability of the turbine housing and the increased degree of efficiency of the exhaust gas turbocharger increased hereby. It can thereby also be provided that the compressor housing of the turbocharger is also formed in several parts.

A further aspect of the invention relates to a method for producing a turbine housing, in particular for an exhaust gas turbocharger of an internal combustion engine, with an exhaust gas guide section, which comprises at least one spiral channel that can be coupled to an exhaust path of an exhaust tract and a reception chamber for a turbine wheel arranged downstream of the at least one spiral channel, in which at least the steps of providing a first and a second partial housing, which comprise complementary wall regions of the spiral channel, positioning of the first partial housing at the second partial housing while forming the spiral channel and connecting the first partial housing to the second partial housing are carried out according to the invention. An improved adaptability to different requirement profiles is enabled hereby, as the turbine housing produced according to the invention and in particular the specially flow-relevant spiral channel can be formed with a considerably increased constructive freedom of designed compared to the state of the art and is not subject to any casting restrictions.

For improving the mechanical rigidity of the turbine housing and a beneficial material availability for the subsequent connection step, the first and the second partial housing are positioned by means of a suitable fit, for example a press fit or a transition fit.

In a further advantageous arrangement of the invention it is provided that the first and the second partial housing are connected to each other by means of a welding method, in particular a laser and or electron beam welding method. In this manner, the required properties with regard to exhaust gas tightness of the spiral channel, mechanical rigidity and minimum distortion are ensured even with a large serial production. The use of a welding method further enables a large automation degree, whereby corresponding time and cost advantages are achieved.

It has thereby further been shown to be advantageous if the first and the second partial housing are welded in the region of a weldable additional material, which is previously arranged in a groove formed in the first and/or in the second partial housing preferably in an annular circumferential manner. In this manner, the required properties with regard to exhaust gas tightness of the spiral channel, mechanical rigidity and minimum distortion can be achieved in a particularly simple way with regard to construction and cost-efficiency. Thereby, an additional material in the shape of a tape can advantageously be arranged in a correspondingly formed groove, in order to generate a material fit along a surface region which is as large as possible.

In a further embodiment, the first or the second partial housing are welded in the region of a surface region which preferably projects from the first and/or second partial housing in an annular circumferential manner so as to form a ledge on which an additional material or wire is arranged at least in sections thereof. This presents an alternative or additional possibility to weld the two partial housings in a simple, fast and operationally safe manner.

Further advantages are obtained in that the first and/or the second partial housing are finished prior to the positioning especially in the complementary wall region. Hereby, inaccessible component regions can be finished in an advantageous manner before the connection of the two partial housings and thus be formed in a particularly accurate manner. The turbine housing and especially the spiral channel of the exhaust gas guide region can hereby adapted to the respective required profile in an optimum manner, whereby corresponding improvements of the thermodynamic degree of efficiency of a flow machine provided with the turbine housing are achieved.

The invention will become more readily apparent from the following description of a particular embodiment thereof on the basis of the accompanying drawings, in which the same elements, or elements that are functionally the same, are provided with identical reference numerals:

### DESCRIPTION OF PARTICULAR EMBODIMENTS

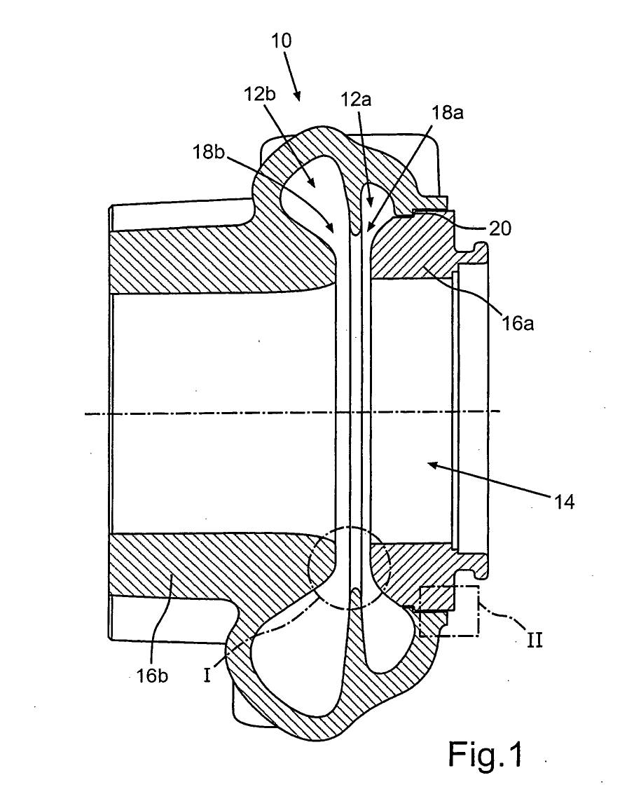

FIG. 1 shows in a cross-sectional view a turbine housing for an exhaust gas turbocharger of an internal combustion engine according to one embodiment,

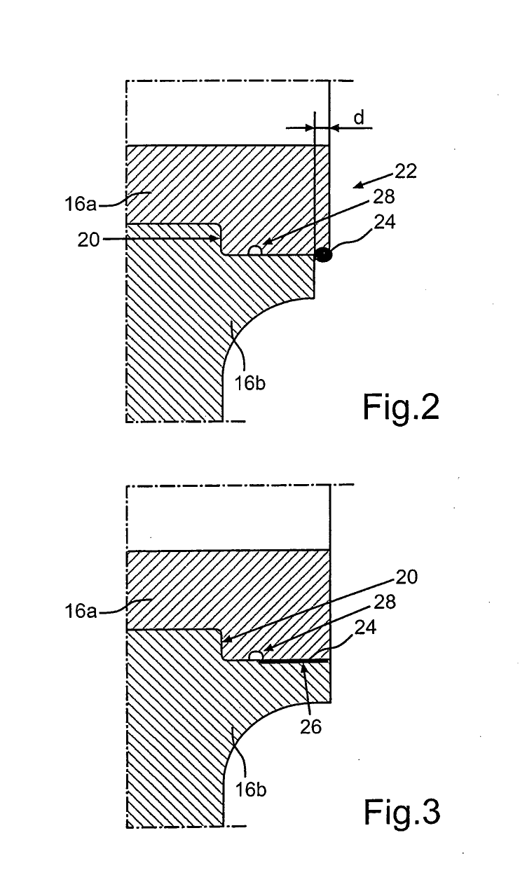

FIG. 2 shows the detail II shown in FIG. 1 in an enlarged view, and

FIG. 3 shows the detail II shown in FIG. 1 in an enlarged depiction in a second version.

### DETAILED DESCRIPTION OF PARTICULAR EMBODIMENTS

FIG. 1 shows a turbine housing for an exhaust gas turbocharger of an internal combustion engine according to one embodiment in a sectional view. The turbine housing thereby comprises an exhaust gas guide region 10, that comprises two spiral channels 12a, 12b that can be coupled to two different exhaust paths of an exhaust tract and a reception chamber 14 arranged downstream of the spiral channels 12a, 12b for accommodating a turbine wheel. A first and a second partial housing 16a, 16b are thereby provided, which comprise complementary wall regions of the spiral channel 12a and are connected to each other while forming this spiral channel 12a in a manner explained in more detail in the following. The two spiral channels 12a, 12b are formed asymmetrically in the present embodiment wherein the larger spiral channel 12b which is less demanding with regard to geometry and tolerances is formed in one part with the second partial housing. It can of course also be provided to form the turbine housing in three or multiple parts or to provide further or symmetrical spiral channels. As with exhaust gas turbochargers or turbine housings, which have spiral channels with such an asymmetrical degree, the respective smaller spiral channel 12a is coupled to the exhaust path of the exhaust tract provided therefore for exhaust gas removal by means of an exhaust gas guide system (not shown), the spiral channel 12a thereby represents a codetermining magnitude with regard to the achievable exhaust gas recirculation rates and the adjusting exhaust gas return rate dispersion. This is amongst others dependent on the geometry and tolerance of the spiral channel 12a and its region 18a, which is constricted in the shape of a nozzle, which is marked as detail I and behind which the exhaust gas flow impacts the turbine wheel arranged downstream in the reception chamber 14. The geometric arrangement of the spiral channel 12a thus considerably influences the result that can be achieved in an exhaust gas test. As the two partial housings 16a, 16b are however produced individually and especially the respective wall regions of the spiral channel 12 can be accessed without problems prior to the connection compared to the state of the art and can correspondingly be finished quickly and simply with small tolerances, the spiral channel 12a can be designed in a more free manner and be formed particularly exact while considering the respective requirement profile. This relates particularly also to the constricted region 18a, whose wall region is essentially formed by the first partial housing 16a. The constricted region 18a can in other words be designed particularly tight or with an optimized shaping. The turbine housing furthermore has the advantages of a high mechanical rigidity with a lowest distortion and enables the provision of exhaust gas turbochargers with improved thermal efficiency.

The manufacture of the shown turbine housing will be explained in more detail on the basis of FIG. 2, which shows the detail II of FIG. 1 in a first version as in enlarged depiction. As can be seen in FIG. 2, the two partial housings 16a, 16b comprise stops 20 corresponding to each other, by means of which the partial housings 16a, 16b are positioned relative to each other. For improving the mechanical rigidity and the favorable material availability during a subsequent welding step, the two partial housings 16a, 16b are engaged first by means of a press fit. In the shown embodiment, the first partial housing 16a comprises, in the connecting region, a surface region 22 projecting from the housing 16b by a distanced so as to form a ledge on which, for material-technical reasons, an additional material 24 of wire is disposed after the positioning of the two partial housings 16a, 16b. The surface region 22 can of course alternatively also be formed at the second partial housing 16b. Subsequently, the first and the second partial housing 16a, 16b are welded to each other by means of a suitable welding method, for example a laser or an electron beam welding method. The additional material 24 ensures a material-locking connection of the two partial housings 16a, 16b while maintaining the required properties with regard to exhaust gas tightness, mechanical rigidity and minimum distortion under conditions of large serial production. For improving the welding properties and the mechanical properties of the turbine housing during the later operation, the first and the second partial housing 16a, 16b and the additional material 24 consist of a material with a thermally high load capacity such as GJS SiMo 5.1 cast iron. The nickel content of the material furthermore lies below 10% and preferably below 8%. Different material pairings may be provided however.

FIG. 3 shows the detail shown in FIG. 1 in an enlarged depiction in a second version for a further embodiment. In contrast to the embodiment shown in FIG. 2 with the first version, presently none of the partial housings 16a, 16b comprises a projecting surface region 22. For the welding of the two partial housings 16a, 16b, the second partial housing 16b has an annular circumferential groove 26, in which the additional material 24 that is in this case in the form of a tape is arranged prior to the positioning of the two partial housings 16a, 16b. The additional material may also be positioned in the groove 26 in the form of a wire.

The first partial housing 16a additionally has a recess 28, by means of which a part of the additional material 24 which melts during the welding can be received to prevent bleeding. Welding according to the previous embodiment may take place additionally. The recess 28 can also be arranged in the second partial housing 16b. The recess 28 is also suitable to receive dirt particles, particles formed during the connection of the partial housings 16a, 16b, or similar.

It is also possible to weld the partial housings 16a, 16b without an additional material with the help of for example an electron beam welding method or a laser welding method with radiation sources having a high brilliance, for example fiber lasers, CO₂ lasers or disk lasers. With these radiation sources, it is possible to produce parallel and small seams, whose structures also have a sufficiently high residual austenitic part in addition to a martensitic part.

What is claimed is:

1. A turbine housing, for an exhaust gas turbocharger of an internal combustion engine with an exhaust gas guide region (10) which has at least one spiral channel (12a, 12b) coupled to an exhaust path of an exhaust tract and a reception chamber (14) for a turbine wheel arranged downstream of the at least one spiral channel (12a, 12b), said housing comprising at least one first and one second partial housing (16a, 16b), which have complementary wall regions of the at least one spiral channel (12a) and are interconnected so as to form at least one spiral channel (12a).

2. The turbine housing according to claim 1, wherein
the first and the second partial housing (16a, 16b) are provided with stops (20), which correspond to each other and by means of which the partial housings (16a, 16b) are accurately positioned relative to each other.

3. The turbine housing according to claim 1, wherein
at least one of the first and the second partial housings (16a, 16b) consist of a material with a high thermal load capacity, including at least one of a ferritic material, preferably a cast iron alloyed with silicon and molybdenum.

4. The turbine housing according to claim 1, wherein
at least one of the first and the second partial housings (16a, 16b) are provided with a recess (28) for receiving particles.

5. The turbine housing according to claim 1, wherein
at least one of the first and the second partial housings (16a, 16b) comprises an annular groove (26) in the connection region, in which an additional material (24) is arranged at least in sections thereof for establishing a material-locking connection between the two partial housings (16a, 16b).

6. The turbine housing according to claim 5, wherein
at least one of the first and the second partial housings (16a, 16b) comprises in the connection area a surface region (22) forming a projecting circumferential ledge, on which a further additional material (24) is arranged and, by means of which a material-locking connection of the two partial housings can be established.

7. The turbine housing according to claim 6, wherein
the additional material (24) consists of the same material as the first and/or the second partial housing (16a, 16b).

8. The turbine housing according to claim 5, wherein
the additional material (24) has a nickel content.

9. The turbine housing according to claim 1, wherein
at least one of the first and the second partial housing (16a, 16b) comprises at least one further spiral channel (12b) that can be coupled to a further exhaust path of the exhaust tract.

10. The turbine housing according to claim 9, wherein
the spiral channel (12a) and the further spiral channel (12b) are formed in a symmetrical and an asymmetrical manner.

11. An exhaust gas turbocharger for an internal combustion comprising a turbine housing, with an exhaust gas guide region (10) which has at least one spiral channel (12a, 12b) coupled to an exhaust path of an exhaust tract and a reception chamber (14) for a turbine wheel arranged downstream of the at least one spiral channel (12a, 12b), said housing comprising at least one first and one second partial housing (16a, 16b), which have complementary wall regions of the at least one spiral channel (12a) and are interconnected so as to form at least one spiral channel (12a)

12. A method for producing a turbine housing for an exhaust gas turbocharger of an internal combustion engine with an exhaust gas guide section (10) which has at least one spiral channel (12a, 12b) that can be coupled to an exhaust path of an exhaust tract and a reception chamber (14) for a turbine wheel arranged downstream of the at least one spiral channel (12a, 12b), said method comprising the following steps:
providing a first and a second partial housing (16a, 16b, which comprise complementary wall regions of the spiral channel (12a),
positioning the first partial housing (16a) at the second partial housing (16b) so as to form the spiral channel (12a), and
interconnecting the first partial housing (6a) to the second partial housing (16b).

13. The method according to claim 12, wherein
the first and the second partial housings (16a, 16b) are joined by means of a press fit.

14. The method according to claim 13, wherein
the first and the second partial housings (16a, 16b) are welded to each other by one of a laser and an electron beam welding method.

15. The method according to claim 14, wherein
the first and the second partial housings (16a, 16b) are welded with a weldable additional material (24), which is arranged beforehand in a groove (26) formed in at least one of the first and the second partial housings (16a, 16b) in an annular circumferential manner.

16. The method according to claim 14, wherein at least one of the first and the second partial housings (16a, 16b) is welded along a ledge formed by a projecting surface region (22) in the connection region in an annular circumferential manner, wherein additional weld material (24) is arranged at least along sections of the connection region.

17. The method according to claim 12, wherein at least one of the first and the second partial housing (16a, 16b) is finished prior to being positioned in the complementary wall region of the spiral channel (12a).
